(19) United States
(12) Patent Application Publication
(10) Pub. No.: US 2026/0038008 A1
(43) Pub. Date: Feb. 5, 2026

(54) COMPUTER-IMPLEMENTED METHOD OF GENERATING AN AI-BASED SUGGESTED ONLINE CUSTOMER REVIEW

(71) Applicant: Best Looking Brand Inc., Boca Raton, FL (US)

(72) Inventor: Samuel Bijou Ballard, Boca Raton, FL (US)

(73) Assignee: Best Looking Brand Inc., Boca Raton, FL (US)

(21) Appl. No.: 19/285,829

(22) Filed: Jul. 30, 2025

Related U.S. Application Data
(60) Provisional application No. 63/677,050, filed on Jul. 30, 2024.

(51) Int. Cl. G06Q 30/0282; H04L 51/02

(52) U.S. Cl. CPC G06Q 30/0282; H04L 51/02

(57) ABSTRACT

A computer-implemented method of generating an AI-based suggested online customer review that includes electronically communicating a sentiment request from the server to a first of the plurality of the electronic devices over a network and in a connectivity session and causing an interface to load thereon displaying an interactive display configured to receive a digital sentiment input therefrom, inserting the digital sentiment input into the interactive display and communicating the digital sentiment input to the server, processing the digital sentiment input and electronically communicating, subject to ascertaining a programmed sentiment threshold, a programmed digital chatbot to the first of the plurality of the electronic devices in the connectivity session, querying the user with the chatbot to receive business review input through therethrough and then generating a textual suggested online customer review with artificial intelligence (AI) utilizing the business review input for integrating into a publicly available online platform.

### FIELD OF THE INVENTION

The present invention relates generally to online customer reviews, and more particularly, to a computer-implemented method and system of generating online customer reviews of products, services, or businesses using artificial intelligence.

### BACKGROUND OF THE INVENTION

The present invention relates generally to online customer reviews and more particularly to a computer-implemented method and system of generating online customer reviews of products, services, or businesses using artificial intelligence.

Customer reviews have grown in value and importance to brands and businesses as more and more prospective customers rely on online customer reviews in selecting a product, service, or business. Writing customer reviews, however, can be a time-consuming process, especially for customers who are not very creative or proficient in the language.

Existing solutions for business owners to gather customer feedback, such as reputation management software and review management applications, still rely on the customers to write a review in their own words. These methods force customers to think creatively and write what comes to mind inside an empty, fill-in-the-blank text box. This approach can be intimidating to many customers who wish to leave a positive review but struggle to find the right words. Moreover, existing review management platforms rely on static input fields and require users to manually compose reviews without AI assistance. While some solutions offer pre-filled templates or reminder emails, none provide an integrated AI-driven assistant that helps users generate natural, personalized reviews based on their experience.

These existing solutions fail to provide a streamlined, user-friendly experience that encourages genuine, detailed reviews. As a result, businesses may receive fewer reviews or lower-quality feedback, impacting their reputation and potential customer trust.

Our invention addresses these shortcomings by introducing a conversational AI chatbot format. The proprietary algorithms effectively train the AI chatbot to ensure an easy, fast, efficient, and accurate review process. The chatbot interacts with customers through a series of prompts, making the review process less daunting. If the customer does not approve of the generated review, they can request revisions, ensuring satisfaction with the final output.

Therefore, a need exists for a more efficient, effective, and engaging method to generate online customer reviews. The present invention provides this by utilizing artificial intelligence to create personalized, high-quality reviews based on user prompts, significantly reducing the effort required from the customer.

### SUMMARY OF THE INVENTION

The invention provides a computer-implemented method of generating an AI-based suggested online customer review that overcomes the hereinafore-mentioned disadvantages of the heretofore-known devices and methods of this general type and that effectively and efficiently enables business and users to leave online business reviews utilizing a specific computer-based process.

With the foregoing and other objects in view, there is provided, in accordance with the invention, a computer-implemented method of generating an AI-based suggested online customer review. The process assists customers/users in generating and publishing online reviews or testimonials through an AI-driven interface. The system supports both form-based and conversational (text or voice) input modes. It uses a combination of fine-tuned large language models (LLMs) and prompt-engineering to create human-like, context-aware reviews based on structured and unstructured user input. Some important features of the present invention include a sentiment-based routing layer (e.g., emoji or star rating) that determines whether a user proceeds to AI-assisted review generation, an adaptive chatbot or form-driven interface that collects user feedback, an AI module trained on large review datasets and guided by structured prompt flows, a natural-language approval and revision loop enabling users to suggest modifications, a copy-to-platform function with review platform integration (e.g., Google, Yelp), and a business dashboard showing approval rates, review completions, and submission data. The system significantly improves review quality, participation rates, and the user experience while allowing businesses to collect authentic, AI-enhanced testimonials at scale.

Although the invention is illustrated and described herein as embodied in a computer-implemented method and system of generating online customer reviews of products, services, or businesses, it is, nevertheless, not intended to be limited to the details shown because various modifications and structural changes may be made therein without departing from the spirit of the invention. Additionally, well-known elements of exemplary embodiments of the invention will not be described in detail or will be omitted so as not to obscure the relevant details of the invention.

It is to be understood that the disclosed embodiments herein are merely exemplary of the invention, which can be embodied in various forms. Therefore, specific structural and functional details disclosed herein are not to be interpreted as limiting, but merely as a basis for future claims and as a representative basis for teaching one of ordinary skill in the art to variously employ the present invention in virtually any appropriately detailed structure. Further, the terms and phrases used herein are not intended to be limiting; but rather, to provide an understandable description of the invention. It is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The attached figures are incorporated in and form part of the specification and serve to further illustrate various embodiments and explain various principles and advantages all in accordance with the present invention. Moreover, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIGS. 1-5 depict exemplary interactive displays generated as part of a computer-implemented method of generating an AI-based suggested online customer review in accordance with the present invention; and

FIG. 6 is a block diagram depicting devices utilized as part of the computer-implemented method of generating an AI-based suggested online customer review in accordance with one embodiment of the present invention.

### DETAILED DESCRIPTION OF INVENTION

The invention described herein provides a computer-implemented method and system that overcomes known disadvantages of those known devices and methods of this general type and that quickly, effectively, and conveniently generates online customer reviews of products, services, or businesses using artificial intelligence.

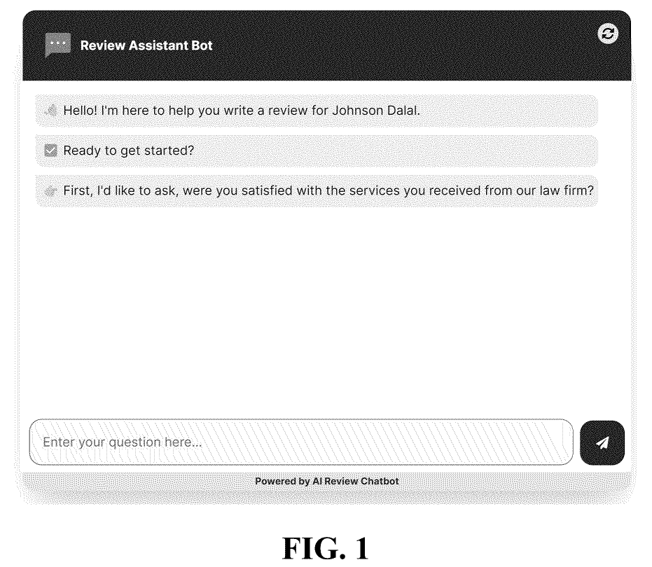

The present invention provides a computer-implemented method and system 100 (hereinafter referred to as “system 100” for brevity) operably configured to generate online customer reviews of products, services, or businesses using artificial intelligence. Powered by a proprietary algorithm and artificial intelligence, the system 100 comprises an online platform or website where customers read and respond to a plurality of written prompts that ultimately help generate a customer review that the user can then publish on various third-party online publicly available platforms or websites (e.g., Google, Yelp, etc.). FIGS. 1-5 depict a plurality of exemplary screen captures from the system 100 which correspond to an exemplary embodiment of the present invention.

The system 100 employs advanced natural language processing (NLP) algorithms to interpret and analyze user inputs. The AI is trained on a vast dataset of customer reviews, enabling it to understand context, sentiment, and typical review structures. This training allows the AI to generate coherent and contextually appropriate reviews that reflect the customer's experiences accurately.

A critical component of the system 100 is the artful creation of detailed prompts that guide the AI in generating reviews. These prompts are designed to elicit specific information from users in a conversational manner, making the review process intuitive and engaging. The prompts are structured to gradually build a comprehensive picture of the user's experience, starting with general satisfaction and delving into more detailed aspects of the product or service.

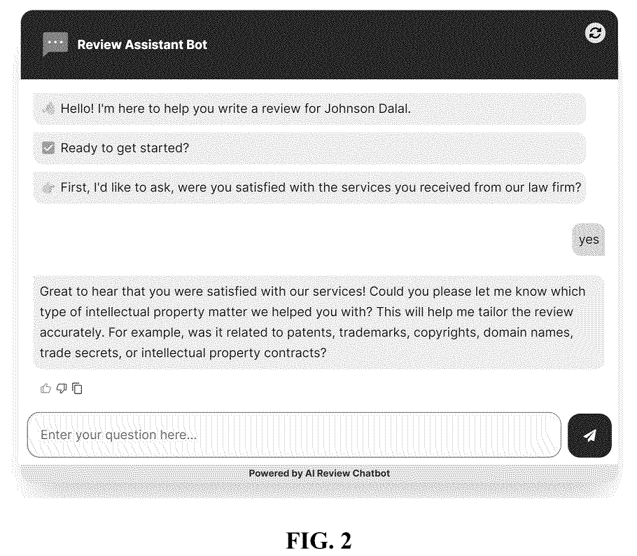

As depicted in FIG. 1, the first written prompt that a user receives inquiries into whether the customer was satisfied with the services, products, etc. that were received. If the customer answers in the affirmative, subsequent prompts, such as the one shown in FIG. 2, gather additional details about the nature of the goods/services received, the quality, and related specifics.

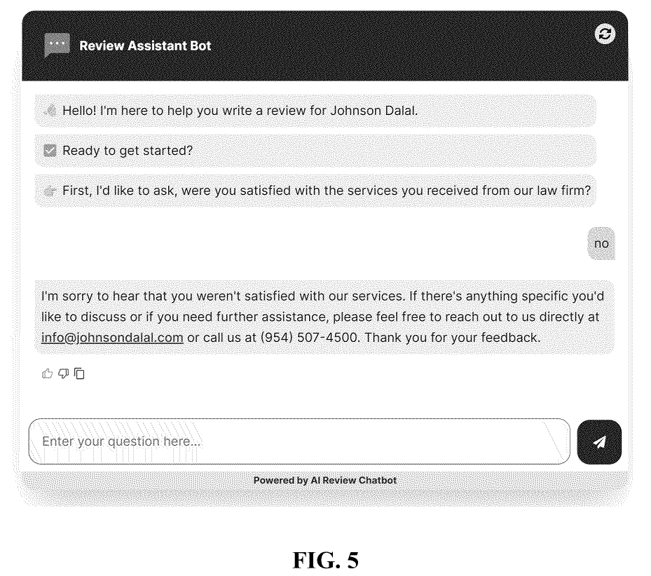

If the customer answers in the negative, the subsequent prompt is depicted in FIG. 5. Specifically, a consumer that was not satisfied with the services or products received will not be prompted to answer any additional prompts or to publish a suggested customer review online.

Assuming the customer answers in the affirmative, the system 100 can generate at least one additional prompt to acquire additional details regarding the nature of the goods/services received, the quality of the goods/services received, and related details. FIG. 2 depicts one exemplary additional prompt.

The system's AI is designed to handle these inputs skillfully, ensuring that the generated review is both accurate and reflective of the user's sentiment. If the customer does not approve of the generated review, they can request the AI chatbot to revise it, providing feedback that the AI uses to make the necessary adjustments.

The proprietary algorithms are continuously refined through machine learning techniques, improving the AI's ability to generate high-quality reviews over time. This iterative process ensures that the system 100 remains effective and reliable, providing businesses with valuable customer feedback and enhancing their online reputation.

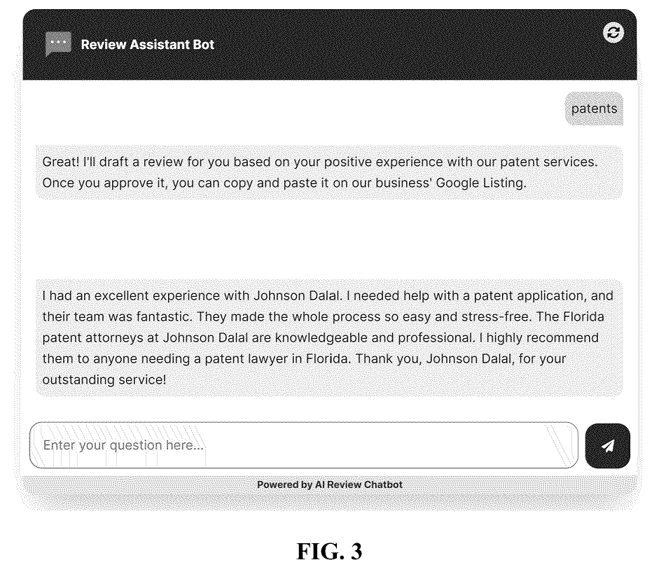

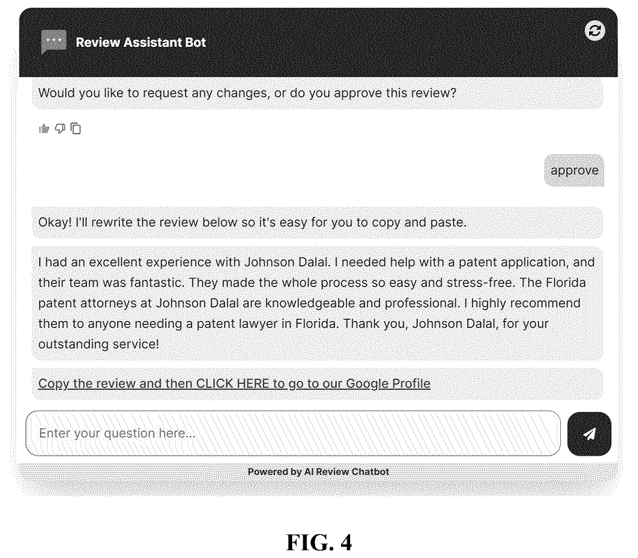

Once the user has responded to all additional prompts generated by the system 100, the system 100 generates a suggested customer review that the user can read and choose to publish on one or more third-party websites or platforms. FIGS. 3-4 depict exemplary screen captures of these additional steps. This beneficially expedites the amount of time it takes for a consumer to write, generate, and publish an online review, and makes the process quicker and more interactive with the user.

Alternative embodiments of the present invention include different methods for generating prompts. In one embodiment, the prompts may include multiple-choice questions or rating scales, simplifying user input. Additionally, the AI module can be implemented using various algorithms, such as rule-based systems or neural networks, each offering distinct advantages in processing and generating reviews.

The user interface can also be adapted for different platforms. While the preferred embodiment is a web-based platform, the system can be implemented as a mobile application, providing users with on-the-go accessibility. These alternative embodiments ensure the system's flexibility and adaptability to different user preferences and technological environments.

The AI module processes user responses by analyzing keywords, sentiment, and context. For example, if a user indicates high satisfaction with a product's quality, the AI incorporates this sentiment into the generated review, producing a detailed and accurate reflection of the user's experience. The AI-generated reviews can vary in length and detail based on user input, providing flexibility and personalization.

The system 100 includes a data storage module operable to store user responses, generated reviews, and revision requests for continuous learning and improvement of the AI module.

In summary, the system 100 offers a novel and efficient method for generating online customer reviews using artificial intelligence. By leveraging advanced NLP, detailed prompting, and machine learning, the system 100 overcomes the limitations of existing solutions, providing a streamlined, user-friendly experience that encourages genuine, high-quality reviews.

Additionally, the present invention discloses a computer-implemented method and system for generating online customer reviews, comprising: a user interface operable to present a plurality of prompts to a user; a natural language processing (NLP) module configured to interpret and analyze user responses to the prompts; an artificial intelligence (AI) module operably configured to generate a suggested online customer review based on the interpreted user responses; a review revision module allowing the user to request modifications to the suggested review; and an output module operable to present the generated review to the user for approval and publishing on third-party platforms.

Additionally, the user interface is designed as a conversational chatbot to engage the user in a dialogic manner, the NLP module is trained on a dataset of customer reviews to understand context, sentiment, and review structures, the AI module employs machine learning techniques to continuously improve the quality of generated reviews based on user feedback and additional data, and the plurality of prompts includes: an initial prompt inquiring about the overall satisfaction of the user with the product or service and subsequent prompts gathering detailed information about specific aspects of the user's experience.

The invention may also include the subsequent prompts are dynamically generated based on the user's responses to previous prompts, the review revision module allows users to provide feedback on the generated review and request specific changes, which are processed by the AI module to revise the review, the output module is configured to format the generated review for compatibility with multiple third-party review platforms, such as Google, Yelp, and others, the AI module generates personalized and contextually appropriate reviews that accurately reflect the user's experience, and the system includes a data storage module operable to store user responses, generated reviews, and revision requests for continuous learning and improvement of the AI module.

Although a specific order of carrying out the inventive method has been described and/or depicted, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

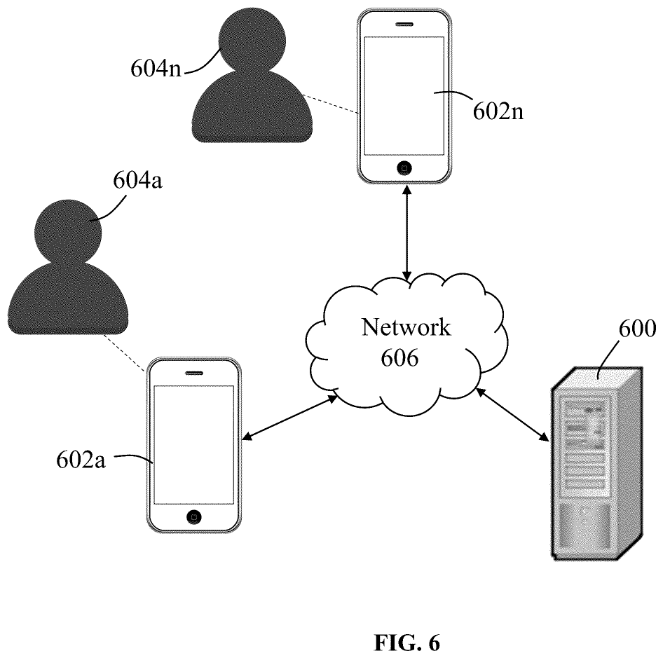

In particular and with reference to FIG. 6, an exemplary block diagram is depicted with a plurality of electronic devices 602a-n and server 600 wirelessly connected over a network 606, e.g., the Internet. The devices 602a-n may be a laptop, phone, desktop, etc. The block diagram will be used to describe the aforementioned computer-implemented method of generating an AI-based suggested online customer review. Specifically, the process may begin and include the steps of providing a server 600 having database and computer processor operably coupled thereto and a plurality of electronic devices 602a-n for a plurality of users 604a-n, wherein “n” represents any number greater than one. The server 600 preferably houses the programmed instructions for carrying out the steps of the present invention.

The process may also include electronically communicating a sentiment request from the server to a first 602a of the plurality of the electronic devices 602a-n over a network 606 and in a connectivity session and causing an interface to load thereon displaying an interactive display configured to receive a digital sentiment input therefrom. Exemplary interactive displays are illustrated in FIGS. 1-5. The process may then proceed to the step of inserting the digital sentiment input into the interactive display of the user 604a and communicating the digital sentiment input to the server 600.

Then, the process may include processing the digital sentiment input with the computer processor, e.g., utilizing an algorithm that may generate a desired result utilizing the digital sentiment input as part of the algorithm-as discussed above. The process may also include electronically communicating, subject to ascertaining a programmed sentiment threshold (e.g., a star-level greater than or equal to three out of five), a programmed interactive business review request including a digital chatbot to the first of the plurality of the electronic devices 602a in the connectivity session. The chatbot is a computer program configured to display on the interactive display and simulate conversation(s)-textually, visually, and/or orally, with human users over the network. The chatbot can mimic human conversation and are preferably implemented as a platform-independent module that is executable and available to the user 602a without needed installation that generate more computer resources.

The next step in the process includes querying the user of the first of the plurality of the electronic devices 602a with the chatbot to receive business review input through therethrough. Next, the process includes generating a textual suggested online customer review with artificial intelligence (AI) utilizing the business review input and then integrating the textual suggested online customer review into a publicly available online platform for the plurality of users 604a-n.

Further, the process may include the aforementioned features described as follows. A sentiment-based routing layer is utilized, wherein the user is asked to rate their experience with a business using either binary emoji interface (e.g., thumbs up/thumbs down) or, for example, a one-to-five-star rating interface. Users who rate positively are routed to AI-assisted review generation. Those who rate negatively are directed to a feedback form for internal review or optionally redirected to a third-party platform for manual review submission. The user input received may include a form-based mode that includes static, customizable form(s) with fields such as dropdowns, single/multi-line inputs, and checkboxes and a conversational mode that includes a dynamic chatbot that interacts with users via text or voice, adapting prompts based on previous answers.

The AI review generation feature of the process includes an AI computer module that is powered by a fine-tuned large language model trained on a corpus of online reviews. Prompt-engineering techniques are used to ensure natural, human-like tone and varied response styles. The AI interprets the collected inputs and generates a draft review. The tone, structure, and detail level are shaped based on sentiment, input type, and business-specific configurations.

Additionally, a review approval and regeneration loop may be initiated once a suggested textual review is generated, wherein the system/chatbot asks the user if the review is acceptable. Examples of natural follow-up prompts include: “Does this sound right to you, or want to tweak it a bit?” or “Would you like me to change anything?”. If the user approves (via detected sentiment or affirmation), a platform-specific “Copy and Paste to [Review Site]” button appears. If not, the user provides freeform feedback, and the AI regenerates a new version based on that guidance.

Additionally, the platform integration feature upon approval includes the user presented with a one-click interface to copy the review for a selected third-party platform. The target platform is determined by the business's settings. Additionally, a business dashboard and analytics is provided to business users that enables access to a dashboard displaying, for example, the number of reviews generated, the review approval/revision rates, completion rates, and platform destinations.

A computer-implemented method operably configured to generate a suggested online customer review has been disclosed that reduces computing resources on a server conventionally utilized to store and process consumer reviews, while also efficiently and effectively generates an online consumer review for a business desired by many business users. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A computer-implemented method of generating an AI-based suggested online customer review comprising the steps of:
providing a server having database and computer processor operably coupled thereto;
providing a plurality of electronic devices for a plurality of users;
electronically communicating a sentiment request from the server to a first of the plurality of the electronic devices over a network and in a connectivity session and causing an interface to load thereon displaying an interactive display configured to receive a digital sentiment input therefrom;
inserting the digital sentiment input into the interactive display and communicating the digital sentiment input to the server;
processing the digital sentiment input with the computer processor and electronically communicating, subject to ascertaining a programmed sentiment threshold, a programmed interactive business review request including a digital chatbot to the first of the plurality of the electronic devices in the connectivity session;
querying the user of the first of the plurality of the electronic devices with the chatbot to receive business review input through therethrough;
generating a textual suggested online customer review with artificial intelligence (AI) utilizing the business review input; and
integrating the textual suggested online customer review into a publicly available online platform for the plurality of users.
